(19) United States
(12) Patent Application Publication
(10) Pub. No.: US 2011/0024063 A1
(43) Pub. Date: Feb. 3, 2011

(54) Interchangeable rolling blind device

(76) Inventor: Hao-Ting Cheou, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,975

(22) Filed: Jul. 29, 2009

(51) Int. Cl. E06B 9/56

(52) U.S. Cl. 160/309

(57) ABSTRACT

An interchangeable rolling blind device in which two interlocking grooves are provided in two control element lead-out apertures opposite to each other at both sides of a mounting seat. A control element guiding block is provided for the penetration of the control element. An insert portion corresponding to the interlocking groove is provided on the control element guiding block. When the mounting seat is secured at either end of blind frame, the insert portion of the control element guiding block is inserted into the interlocking groove of the control element lead-out aperture in the designated direction.

### BACKGROUND OF THE INVENTION

1. Field of the Invention

This invention relates to an interchangeable rolling blind device particularly to an interchangeable rolling blind device which has no need to differentiate the directionality of the mounting seat in manufacturing thereof, and the mounting seat can be interchanged and adjusted at the left and right ends of the blind frame according to different demand at installation site. Thus, only single set of mounting seat can fulfill the requirement at installation site, so that following effects can be achieved: saving expense of mould; becoming easier and more convenient in manufacturing and assembling; and reducing remarkable storage space. Moreover, as the control element in the mounting seat is led out by the control element guiding block, there is a distance present between the control element and the rolling blind. This can prevent the control element and the rolling blind from interference and entanglement with each other. It can increase more practical convenience in the integral embodiment and usage thereof.

2. Brief Description of the Prior Art

Mounting a window in airtight room can improve not only ambient lighting so as to enhance indoor brightness of illumination but also indoor air ventilation so as to make the interior of house nice and cool with better ventilation. However, mounting a window also causes some problems, such as: inside state being peeped by outsider; inside being irradiated directly by sunshine such that light beam is harsh to the eye; and indoor temperature is arisen. Due to the above problems, the common people adds blind at the inner side of the window, so that users draw the blind open or close in order to adjust indoor light brightness and to protect indoor state from being peeped by outsider. With the boost in the evolution on window blind, a variety of window blind has been developed and thus sold on market, such as conventional fabric type, blinds, roll-up type, drapery-fabric Roman type, and pleated type.

With respect to the common roll-up type blind, it essentially incorporates a mounting seat in cooperation with a blind frame, and a reel control assembly is provided within the mounting seat. A control element, such as a beaded chain or pull cord, is fitted on the reel control assembly. The inside end face of the reel control assembly is combined with a reel provided in the blind frame such that the reel control assembly will drive a reel in the blind frame to rotate together so as to roll up or down the blind by the reel, when the control element is pulled by user to rotate the reel control assembly.

The abovementioned roll-up type window blind can achieve the anticipated effect of controlling the rotation of the reel provided within the blind frame by means of the reel provided in the mounting seat, but some shortcomings, which will described further in detail as below, has been found in practical implementation. Due to specific limitation at each installation site, the mounting seat should be secured at specific end of the blind frame according to the condition at installation site. Thus, different mounting seat should be prepared to cope with the case which has different lead-out direction for the control element. In this case, not only two sets of mould should be prepared in order to meet the installation demand, but also the manufacturing and assembling process for the mounting seat is troublesome and inconvenient. It means the manufacturing cost is soaring up. Additionally, storage management becomes complicated, as there are two different kinds of mounting seat to be separately handled. This means more storage space is required. What is more, if wrong mounting seat is carried to the installation site, it just wastes time to go back and take the right one. Therefore, this roll-up type blind assembly still has space for improvement on its total implementation.

In view of the above shortcomings, the inventor of this invention proposes an interchangeable rolling blind according to the research and improvement conducted on conventional structure and its defects, based on profound experience in R&D and manufacturing in relevant field, with a purpose to achieve better performance value in practical application.

### SUMMARY OF THE INVENTION

This invention is to provide an interchangeable rolling blind device in which two control element lead-out apertures opposite to each other are provided at both sides of a mounting seat, two interlocking grooves corresponding to the control element lead-out apertures being provided, a control element guiding block being provided for the penetration of the control element, an insert portion corresponding to the interlocking groove being provided on the control element guiding block. When the mounting seat is installed at either end of blind frame, the insert portion of the control element guiding block is inserted into the interlocking groove of the control element lead-out aperture in the designated direction. In this manner, there is no need to differentiate the directionality of the mounting seat in the manufacturing of the mounting seat, the mounting seat can be interchanged and adjusted at the left and right ends of the blind frame according to a variety of demand. Thus, only single set of mounting seat can fulfill the requirement at installation site, so that the following effects can be achieved: saving expense of mould; becoming easier and more convenient in manufacturing and assembling; and reducing remarkable storage space. Moreover, as the control element in the mounting seat is led out by the control element guiding block, there is a distance present between the control element and the rolling blind. This can prevent the control element and the rolling blind from interference and entanglement with each other. It can increase more practical convenience in the integral embodiment and usage thereof.

### BRIEF DESCRIPTION OF THE DRAWINGS

FIG. 1 is a perspective exploded view of the present invention.

FIG. 2 is a perspective exploded view showing another side of the present invention.

FIG. 3 is a perspective view showing the state of use of the present invention.

FIG. 4 is a sectional view showing the state of use of the present invention.

FIG. 5 is another perspective view showing the state of use of the present invention.

FIG. 6 is another sectional view showing the state of use of the present invention.

### DETAILED DESCRIPTION OF PREFERRED EMBODIMENTS

The technical content, objects and effectiveness of the present invention will become more apparent by the detailed description of a preferred embodiment of the present invention in conjunction with the accompanying drawings.

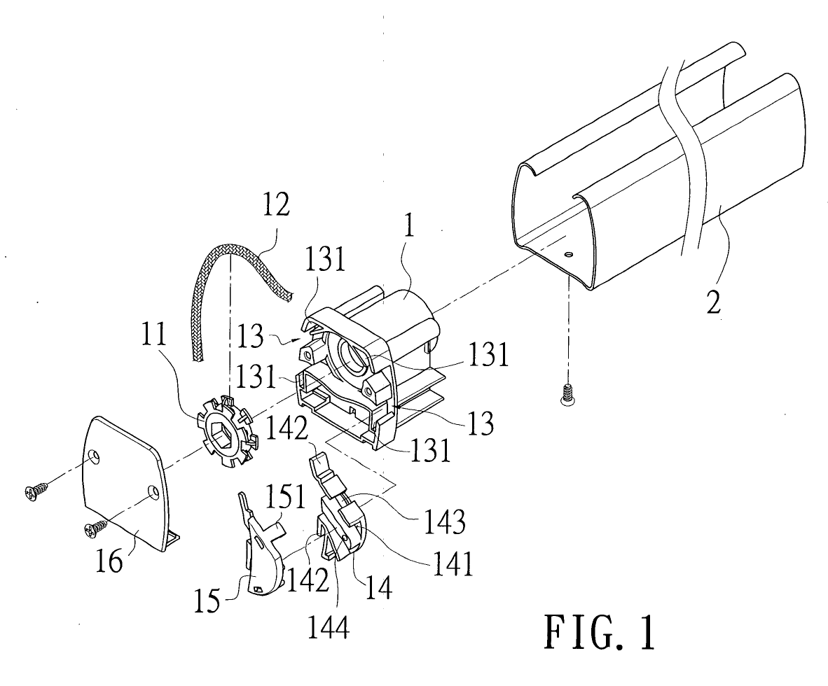

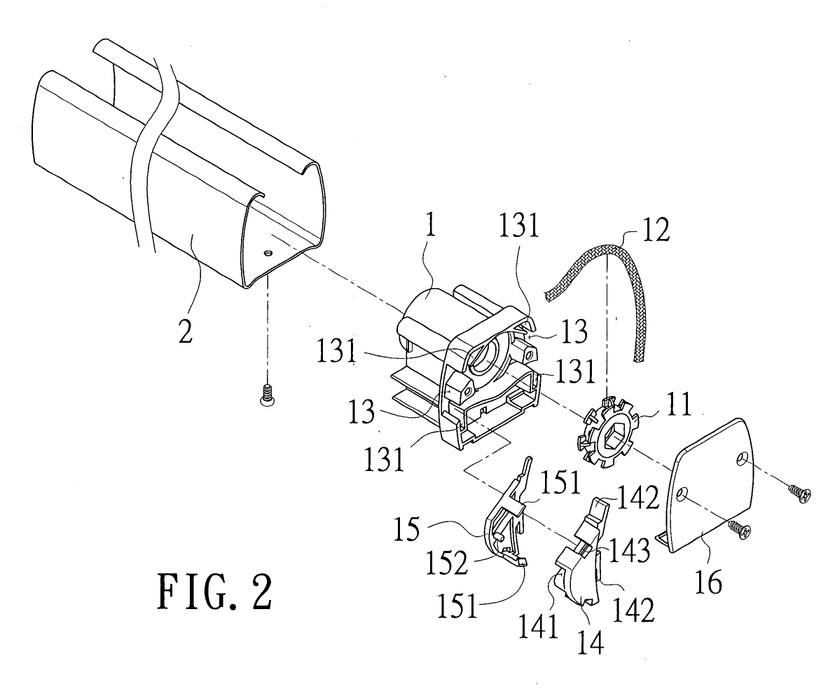

FIG. 1 is a perspective exploded view of the present invention, and FIG. 2 a perspective exploded view of another side of the present invention. As shown in these figures, this invention is essentially constituted by a mounting seat (1) in cooperation with a blind frame (2), in which the mounting seat (1) can be installed at designated end of the blind frame (2) according to the demand decided by space limitation.

The mounting seat (1) is provided with a reel control assembly (11) which is provided for engaging with a control element (12), such as a beaded chain or pull cord etc. Two control element lead-out apertures (13) opposite to each other are provided at both sides of the mounting seat (1), and two interlocking grooves (131) corresponding to the control element lead-out apertures (13) are provided. Additionally, a control element guiding block (14) having a through orifice (141) for penetration of the control element (12) is provided. An insert portion (142) corresponding to the interlocking groove (131) of the control element lead-out aperture (13) is provided on the control element guiding block (14). Moreover, a slot portion (143) and a positioning hole (144) are provided on the control element guiding block (14). A cover detent body (15) matching with the control element guiding block (14) is provided, which has a detent block (151) and a positioning post (152) corresponding to the slot portion (143) and the positioning hole (144) respectively. The cover detent body (15) can be fixed at the outside of the control element guiding block (14) both by the interlocking of the detent block (151) with the slot portion (143) and by the engagement of the positioning post (152) in the positioning hole (144). Finally, a cover body (16) is fixed at the outside of the mounting seat (1).

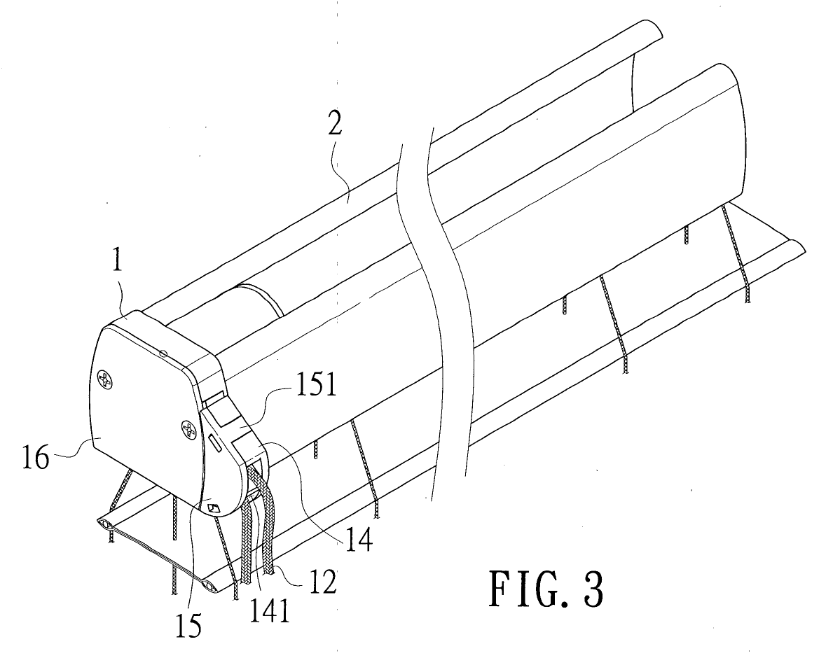

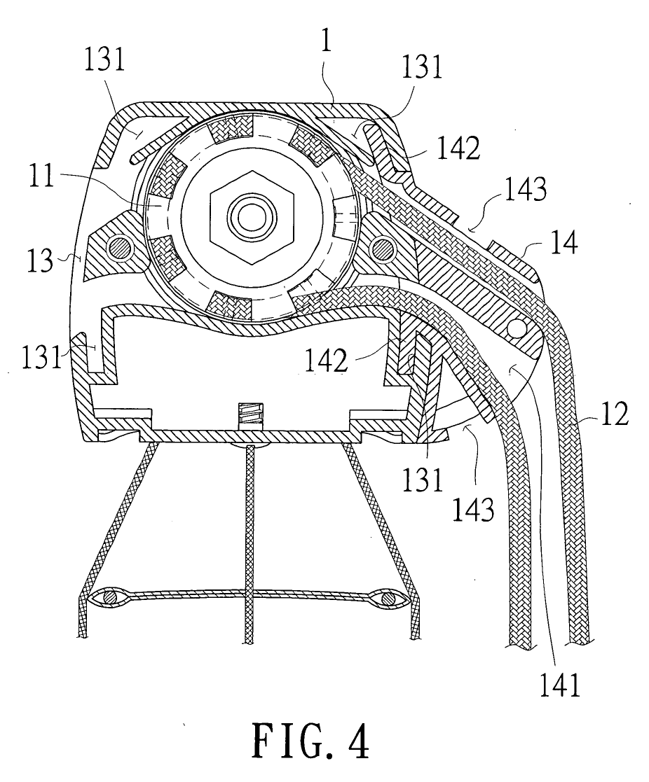

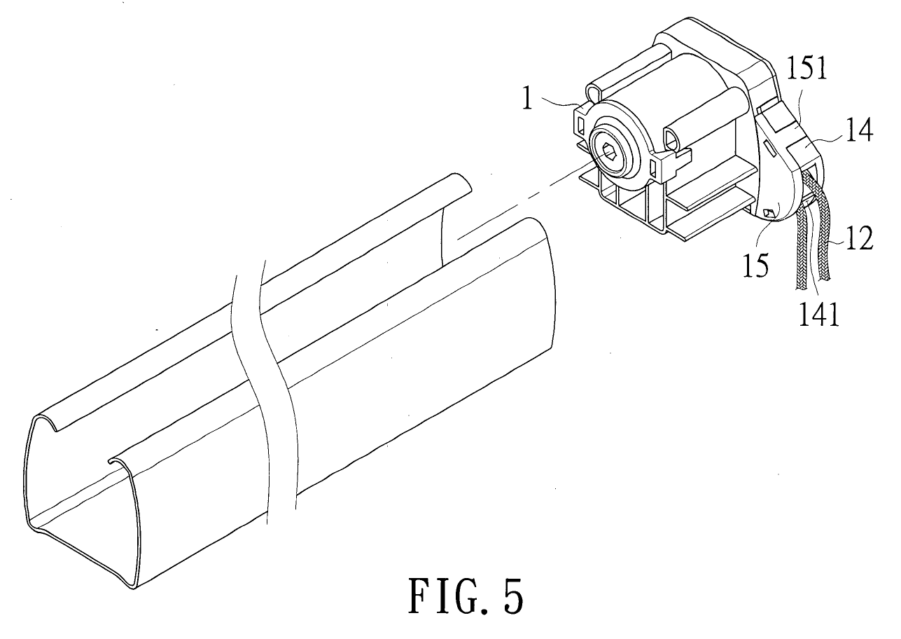

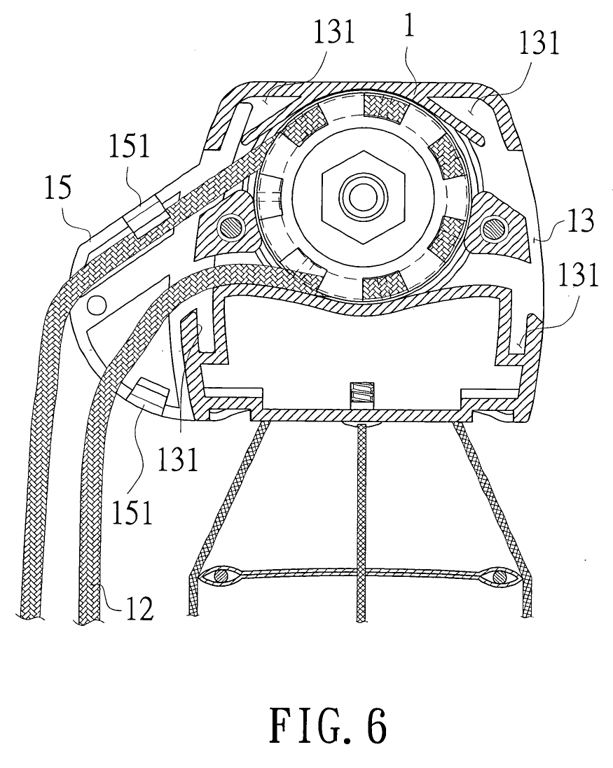

FIG. 3 is a perspective view showing the state of using of the present invention; FIG. 4 is a sectional view showing the state of using of the present invention; FIG. 5 is another perspective view showing the state of using of the present invention; and FIG. 6 is another sectional view showing the state of using of the present invention. As shown in FIGS. 3 to 6, when the rolling blind is installed, the mounting seat (1) can be fixed at either end of the blind frame (2) according to space limitation at installation site. In accordance with the direction designated by the installation of the mounting seat (1), the control element guiding block (14) is inserted in such a way that the insert portion (142) is inserted into the interlocking groove (131) of the control element lead-out aperture (13) located at the outside of the mounting seat (1). Then, the control element (12) passes through the control element lead-out aperture (13) and is led out through the through orifice (141) of the control element guiding block (14). Thus, in the manufacturing and assembling of the mounting seat (1), there is no need to differentiate the directionality of the mounting seat (1) which can be mounted smoothly at either side of the blind frame (2).

Based on the foregoing description of the elements constitution and the embodiment of the present invention, when the mounting seat of the present invention is secured at either end of the blind frame, the control element guiding block is inserted in accordance with the designated direction of the mounting seat such that the insert portion is inserted into the interlocking groove of the control element lead-out aperture, and the control element in the mounting seat can be led out from the through orifice of the control element guiding block. Therefore, the mounting seat can be interchanged and adjusted at the left and right ends of the blind frame according to specific demand at installation site, there is no need to differentiate the directionality of the mounting seat in the manufacturing and assembling of the mounting seat. In other words, only single set of mounting seat can fulfill the requirement at the installation site, so that the following effects can be achieved: saving expense of mould; becoming easier and more convenient in manufacturing and assembling; and reducing remarkable storage space. Moreover, as the control element in the mounting seat is led out by the control element guiding block, there is a distance present between the control element and the rolling blind. This can prevent the control element and the rolling blind from interference and entanglement with each other. It can increase more practical convenience in the integral embodiment and usage thereof.

The above embodiment and drawings are not intended to limit the structural aspect of the present invention. Variations or modifications conducted by the person having ordinary skill in this art without departing from the spirit and features of the present invention are regarded to be still within the scope of the invention.

Summing up above, the embodiment of the present invention is surely able to reach expected effectiveness in application, and the specific structure disclosed herein is not only unprecedented in the same category of product but also not open to the public before application.

What is claimed is:

1. An interchangeable type rolling blind device, essentially constituted by a mounting seat in cooperation with a blind frame, wherein:
a. said mounting seat can be secured at designated end according to specific demand at installation site;
b. a reel control assembly is provided within said mounting seat and a control element is fitted on the reel control assembly;
c. two control element led-out apertures opposite to each other are provided at both sides of said mounting seat and two interlocking grooves with respect to said control element led-out aperture are provided;
d. a control element guiding block which has a through orifice for the penetration of said control element is also provided;
e. an insert portion corresponding to the interlocking groove is provided on said control element guiding block.

2. An interchangeable type rolling blind device as claimed in claim 1, wherein:
a. a slot portion and a positioning hole are provided on said control element guiding block;
b. a cover detent body matching with said control element guiding block is provided to have a detent block and a positioning post corresponding to the slot portion and the positioning hole respectively;
c. said cover detent body can be secured and combined at the outside of said control element guiding block both by the interlocking of the detent block with the slot portion and by the engagement of the positioning post in the positioning hole.
